(19) United States
(12) Patent Application Publication
(10) Pub. No.: US 2014/0026188 A1
(43) Pub. Date: Jan. 23, 2014

(54) SYSTEMS, METHODS, AND DEVICES FOR RESTRICTING USE OF ELECTRONIC DEVICES BASED ON PROXIMITY TO WIRELESS DEVICES

(71) Applicant: Justin L. Gubler, Scottsdale, AZ (US)

(72) Inventor: Justin L. Gubler, Scottsdale, AZ (US)

(21) Appl. No.: 13/859,727

(22) Filed: Apr. 9, 2013

Related U.S. Application Data
(60) Provisional application No. 61/674,568, filed on Jul. 23, 2012.

(51) Int. Cl. H04W 12/08

(52) U.S. Cl. CPC H04W 12/08
USPC 726/3

(57) ABSTRACT

Systems, kits, methods, and software are disclosed for securing access to an electronic device such as a smartphone, tablet, e-reader, portable media player, and the like. The electronic device includes a security application and a network interface. The network interface is configured to be paired with or otherwise communicatively connect to a separate security device. If the application determines that communication is possible or occurring, access to the electronic device may be enabled. If the application determines that communication is not possible, some, all, or substantially all features of the electronic device may be disabled. The disabled device may be re-enabled manually using an override code, or automatically be re-initiating communication with the security device.

### CROSS-REFERENCE TO RELATED APPLICATIONS

This application claims the benefit under 35 U.S.C. §119(e) of U.S. Patent Application Ser. No. 61/674,568, filed on Jul. 23, 2012 and titled “SYSTEM FOR AUTOMATICALLY RESTRICTING ACCESS TO A PORTABLE ELECTRONIC DEVICE, AND METHODS AND DEVICES ASSOCIATED THEREWITH,” which application is hereby expressly incorporated herein by this reference in its entirety.

### TECHNICAL FIELD

The disclosure relates to electronic devices. More specifically, embodiments of this disclosure relate to secure portable electronic devices against unauthorized use. More particularly still, embodiments of the present disclosure relate to software, systems, devices, methods, and computer-readable media for restricting access to portable electronic devices. In some embodiments, a portable electronic device may determine whether a wireless device is near the portable electronic device. When the wireless device is nearby, access to the portable electronic device may be enabled. When the wireless device is determined not to be nearby, or cannot be identified by the portable electronic device, the portable electronic device may disable some or all access to the portable electronic device

### BACKGROUND

Since the advent of mobile computing, portable electronic devices have become increasingly portable, easier to use, powerful and affordable. As a result, the frequency with which portable electronic devices are used, and the variety of tasks that may be performed are also ever-increasing. In fact, users of portable electronic devices will often access such devices many times throughout a single day, and access many different types of information or services.

The increased portability and technological capabilities of portable electronic devices have largely been made possible by advances in technology that allow processors, storage and memory devices, input/output devices and components, network communication devices, and other computing elements and systems to be smaller and more powerful. Such advances have affected nearly every type of portable electronic device, and allowed even more categories to be created. For instance, in the past, cellular or mobile phones were primarily used for voice communication. Such devices increasingly incorporate additional features, and now can include calendaring features, computer games, calculators, and the like. A particular class of cellular or mobile phones, the so-called “smart phones” are also being produced in increasingly large quantities. Smart phones significantly expand the capabilities of a traditional mobile phone, and may allow not only voice communication and other features of earlier mobile phones, but also allow web browsing, video communication, email access, use of productivity software (e.g., word processing, spreadsheets, etc.), playing of graphics intensive video games, and the like. Additional types of portable electronic devices with varying but generally increased capabilities may include “slate” or “tablet” computers, e-readers, hand-held multimedia devices, cameras, GPS devices, or any other portable electronic device.

Due at least in part to the increased capabilities of such devices and our reliance on such devices, portable electronic devices also continue to store or access more and more information. Often, the information that can be stored on or accessed by a portable electronic device includes personal information about the user or the user's family, friends, co-workers, clients, suppliers, customers, and the like, and may thus be of a very personal or confidential nature. For instance, a user may store or access financial account information through the portable electronic device, store passwords, and the like. Bank accounts, email accounts, credit card information, office network login information, social media access information, and the like may all be stored on or accessible through a portable electronic device. As a result, if the portable electronic device is lost or misplaced, there may be significant expense in terms of replacement costs as well as risk associated with use of the personal or confidential information to whoever may find the device. A person with malicious intent could misuse such information and cause significant financial or other damage.

### SUMMARY

In accordance with aspects of the present disclosure, embodiments of devices, systems, methods, software, computer program products, and the like are described or would be understood and which relate to security of electronic devices. Security may be provided by linking or pairing an electronic device with a separate security device. Through a communication protocol, the electronic device may attempt to find, identify, or communicate with the security device. If the attempt is successful, the electronic device may operate in an accessible or unlocked manner. If the attempt is unsuccessful, or if communication later fails, the electronic device may have all or some of its functions disabled or locked.

According to some aspects of the present disclosure, a method implemented using one or more computing systems may secure access to one or more components of an electronic device. In such a method, a security device may be identified by the electronic device. Wireless communication may be attempted with the security device. When communication fails, access to the one or more components of the electronically device may be automatically disabled.

In accordance with another aspect that may be combined with any one or more other aspects herein, a computer-program product may be provided to secure an electronic device. The computer-program product may include one or more computer-readable media with computer-executable instructions stored thereon that, when executed by one or more processors, causes an electronic device to perform certain functions. Such functions may include identifying an electronic security device and/or attempting to communicate with, or find, the identified security device. Such functions may also include basing access to components of the electronic device on an ability of the electronic device to communicate with the electronic security device. Consequently, when communication is not available, increased security, and lowered user access, may be provided.

In accordance with another aspect that may be combined with any one or more other aspects herein, another method may include associating at least one security device with a security application of a portable electronic device. Using a short-range wireless component, the portable electronic device may connect to the security device. The status of the connection may be repeatedly monitored, and a lost connection can be detected. After detecting the lost connection, a lock can be provided to substantially lock all access to the portable electronic device. A display may also present an override interface to allow the user to override the lock.

In accordance with another aspect that may be combined with any one or more other aspects herein, an electronic device may include one or more processing components and a network interface for wirelessly communicating with an electronic security device. One or more additional components may be provided which access computer-executable instructions for securing access to the electronic device using the network interface. When the network interface is able to be paired with the electronic security device, lower security may be provided compared to when the network interface is unable to be paired with the electronic security device.

In accordance with another aspect that may be combined with any one or more other aspects herein, an electronic device may communicate with a security device using a low power and/or short range communication protocol.

In accordance with another aspect that may be combined with any one or more other aspects herein, a communication protocol may be a point-to-point communication protocol.

In accordance with another aspect that may be combined with any one or more other aspects herein, a communication protocol may include Bluetooth.

In accordance with another aspect that may be combined with any one or more other aspects herein, a security device may be dedicated primarily to securing access of an electronic device.

In accordance with another aspect that may be combined with any one or more other aspects herein, a security device may include security features integrated with additional or other features.

In accordance with another aspect that may be combined with any one or more other aspects herein, a security device may include a keychain, key ring, wristband, watch, or pen.

In accordance with another aspect that may be combined with any one or more other aspects herein, a security device may include audio input and/or output capabilities.

In accordance with another aspect that may be combined with any one or more other aspects herein, an electronic device may automatically check a communication status with the security device.

In accordance with another aspect that may be combined with any one or more other aspects herein, automatic checking of a communication status may be performed prior to locking substantially all access to an electronic device when communication fails.

In accordance with another aspect that may be combined with any one or more other aspects herein, an attempt to communicate with a security device may include determining an electronic device is not within range of the security device.

In accordance with another aspect that may be combined with any one or more other aspects herein, a communication range may be up to about one hundred feet (30.48 meters), up to about fifty feet (15.24 meters), up to about thirty feet (9.14 meters), up to about fifteen feet (4.57 meters), or up to an amount less than fifteen feet (4.57 meters) or more than one hundred feet (30.48 meters).

In accordance with another aspect that may be combined with any one or more other aspects herein, communication between an electronic device and a security device may be monitored substantially continuously.

In accordance with another aspect that may be combined with any one or more other aspects herein, communication between an electronic device and a security device may be monitored intermittently.

In accordance with another aspect that may be combined with any one or more other aspects herein, communication between an electronic device and a security device may be monitored at a user configurable delay.

In accordance with another aspect that may be combined with any one or more other aspects herein, identifying a security device may include, at the electronic device, associating an identification with the security device.

In accordance with another aspect that may be combined with any one or more other aspects herein, an identification may include a MAC address.

In accordance with another aspect that may be combined with any one or more other aspects herein, an electronic device that is fully or partially disabled due to a security device being out of range relative to the portable electronic device may be unlocked.

In accordance with another aspect that may be combined with any one or more other aspects herein, unlocking the electronic device may be performed in response to manual input.

In accordance with another aspect that may be combined with any one or more other aspects herein, unlocking the electronic device may be performed automatically by determining the security device is within a communication range of the electronic device.

In accordance with another aspect that may be combined with any one or more other aspects herein, an electronic may abstain from disabling access to some or all components of an electronic device when communication is available with a security device.

In accordance with another aspect that may be combined with any one or more other aspects herein, restricting substantially all access to an electronic device may allow one or more of making emergency calls, input of override credentials, time/date display, or display of owner information.

In accordance with another aspect that may be combined with any one or more other aspects herein, disabling some or all features of an electronic device may include triggering a lock interface native to the electronic device.

In accordance with another aspect that may be combined with any one or more other aspects herein, disabling some or all features of an electronic device may include using a lock interface specific to the security application of the electronic device.

In accordance with another aspect that may be combined with any one or more other aspects herein, disabling access to some or all components of an electronic device may include presenting a visual or audible cue indicating communication with a security device is lost.

In accordance with another aspect that may be combined with any one or more other aspects herein, disabling access to some or all components may be performed automatically, even without a response to a visual or audible cue.

In accordance with another aspect that may be combined with any one or more other aspects herein, an electronic device may be used to access a security application on the electronic device.

In accordance with another aspect that may be combined with any one or more other aspects herein, a security application may manage communications with the security device.

In accordance with another aspect that may be combined with any one or more other aspects herein, access to a security application may be protected using an authentication or lock interface.

In accordance with another aspect that may be combined with any one or more other aspects herein, an authentication or lock interface for accessing the security application may be a same interface used to lock some or all access to the electronic device.

In accordance with another aspect that may be combined with any one or more other aspects herein, an authentication or lock interface for accessing the security application may be a different interface relative to the interface used to lock some or all access to the electronic device.

In accordance with another aspect that may be combined with any one or more other aspects herein, an electronic device may access a security application for accessing a network interface of the electronic device.

In accordance with another aspect that may be combined with any one or more other aspects herein, a security application may be configured to evaluate an ability of the network interface to connect to a network interface of a security device.

In accordance with another aspect that may be combined with any one or more other aspects herein, a hardware component may be configured to evaluate an ability of the network interface to connect to a network interface of a security device.

In accordance with another aspect that may be combined with any one or more other aspects herein, a security device may be a so-called dumb device lacking significant processing and/or display capabilities.

Other aspects, as well as the features and advantages of various aspects, of the present disclosure will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain embodiments that fall within the broad scope of the disclosed subject matter will be rendered in the appended drawings. Understanding that these drawings only depict example embodiments and are not therefore to be considered to be limiting in scope, nor drawn to scale for all embodiments, various embodiments will be described and explained with additional specificity and detail through the use of the accompanying drawings in which:

FIG. 1A is a perspective view of an example embodiment of an electronic device, in accordance with one embodiment of the present disclosure;

FIG. 1B schematically illustrates the electronic device of FIG. 1A, according to an embodiment of the present disclosure;

FIG. 2A is a perspective view of an example wireless security device in accordance with one embodiment of the present disclosure;

FIG. 2B schematically illustrates the wireless security device of FIG. 2A, according to an embodiment of the present disclosure;

FIG. 3 illustrates the example wireless security device of FIG. 2A within range of, and securing, the electronic device of FIG. 1A, according to an embodiment of the present disclosure;

FIG. 4 illustrates the example wireless security device of FIG. 2A out of wireless range of, and securing, the electronic device of FIG. 1A, according to an embodiment of the present disclosure;

FIG. 5 is a flow chart of an example method for securing access to an electronic device, according to an embodiment of the present disclosure;

FIGS. 6A-6N illustrate an example a electronic device implementing a method for securing the electronic device, according to an embodiment of the present disclosure;

FIGS. 7A-7C illustrate an example electronic device displaying any of various lock screens, according to an embodiment of the present disclosure; and

FIG. 8 illustrates an example electronic device as secured using any of multiple wireless security devices, according to an embodiment of the present disclosure.

### DETAILED DESCRIPTION

Systems, methods, devices, software and computer-program products according to the present disclosure may be configured for use in enabling or disabling access to an electronic device. By way of example and not limitation, such security may be provided for portable electronic devices, including: smart phones or other mobile phones (e.g., IPHONE® devices available from Apple Inc., devices running the ANDROID™ operating system produced by Google Inc., BLACKBERRY® devices available from Research in Motion Limited, devices running the WINDOWS® operating system produced by Microsoft Corporation, etc.); slate or tablet computers (e.g., the IPAD® devices available from Apple Inc., the XOOM™ available from Motorola Mobility, Inc., the BLACKBERRY PLAYBOOK™ available from Research in Motion Limited, the STREAK™ available from Dell Inc., the HP TOUCHPAD™ available from Hewlett-Packard Co., the GALAXY™ branded devices available from Samsung Electronics Co., Ltd., etc.); and portable media players (e.g., the IPOD® devices available from Apple Inc., the ZUNE® devices available from Microsoft Corporation, the SANSA® devices available from SanDisk Corporation, etc.). Additional types of portable electronic devices may include e-readers, (e.g., the KINDLE® devices available from Amazon Technologies, Inc., the NOOK™ devices available from Barnes & Noble, Inc., etc.), or any other portable electronic devices, including laptops, GPS devices, watches, cameras, and the like.

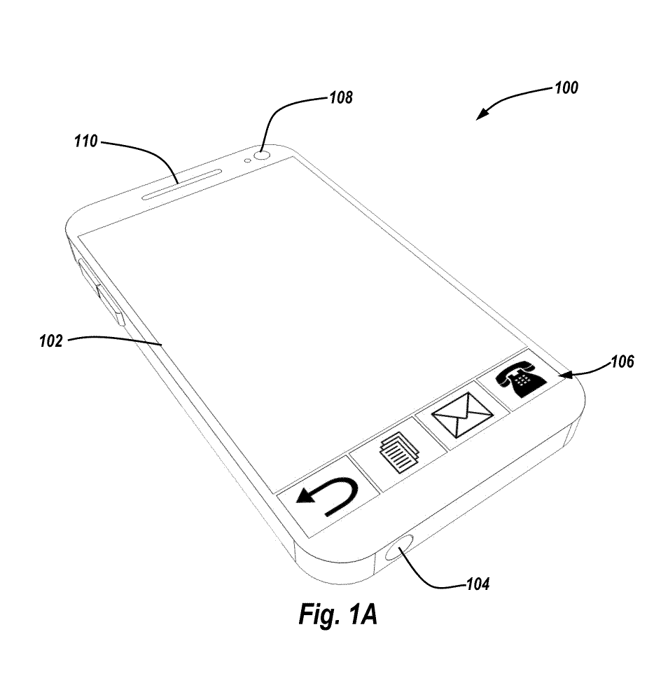

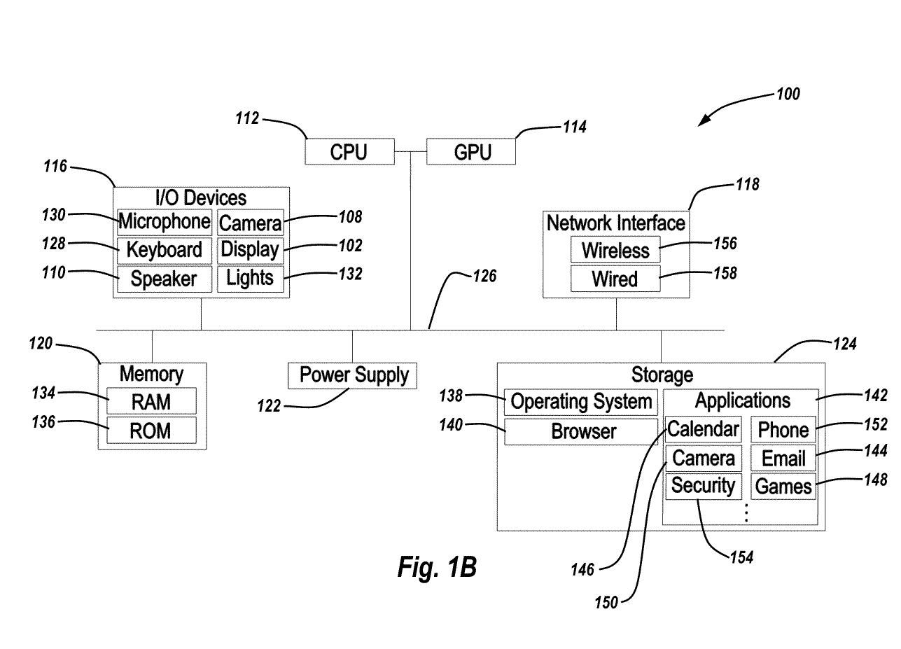

Turning now to FIGS. 1A and 1B, an example electronic device 100 is shown in perspective and schematic views. FIG. 1A, for instance, illustrates the electronic device 100 as a portable electronic device, and more particularly as a smart-phone device. Of course, the illustrated electronic device 100 is merely illustrative, and may include other types of devices (e.g., laptop, tablet, e-reader, media player, etc.). As discussed herein, the electronic device 100 is one type of electronic device that may be secured using a wireless security device.

More particularly, the illustrated electronic device 100 may include various features, including one or more inputs or outputs (e.g., display 102, port 104, buttons 106, camera 108, speaker 110, etc.). Such features may collectively be used to operate the electronic device 100 to process, display, receive, transmit, create, or otherwise use data of various types.

A more particular illustration of some example components of the electronic device 100 is shown in FIG. 1B, in which the electronic device 100 is schematically illustrated. The illustrated electrical devices may include, by way of illustration and not limitation, cell phones, smart phones, personal digital assistants (PDAs), land-line phones, tablet computing devices, netbooks, e-readers, laptop computers, desktop computers, media players, global positioning system (GPS) devices, watches, two-way radio devices, other devices capable of communicating over the network or otherwise establishing a communication session or link (e.g., with an electronic security device as discussed herein).

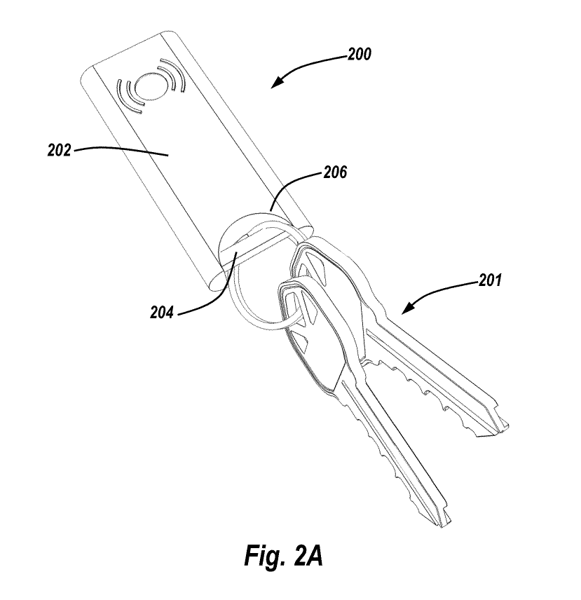

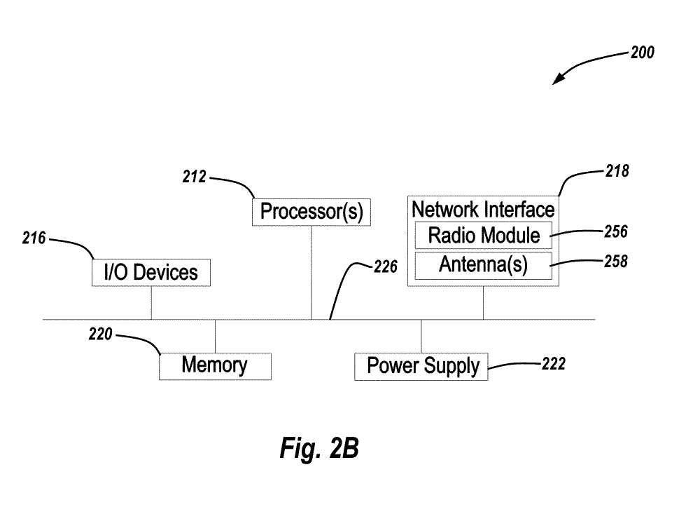

In FIG. 2B, the electronic device 100 includes multiple components that may interact together over one or more communication channels, and can optionally be used to maintain internal or external communication. In this embodiment, for instance, the system may include multiple processing units. More particularly, the illustrated processing units include a central processing unit (CPU) 112 and a graphics processing unit (GPU) 114. The CPU 112 may generally be a multi-purpose processor for use in carrying out instructions of computer programs of the system 100, including basic arithmetical, logical, input/output (I/O) operations, or the like. In contrast, the GPU 14 may be primarily dedicated to processing of visual information. In one embodiment, the GPU 114 may be dedicated primarily to constructing images intended to be output to one or more display devices 102. In other embodiments, a single processor or multiple different types of processors may be used other than, or in addition to, those illustrated in FIG. 1.

The CPU 112, GPU 114 or other processing components may interact or communicate with input/output (I/O) devices 116, a network interface 118, memory 120, a power supply 122, one or more mass storage devices 124, or other components. One manner in which communication may occur is using a communication bus 126, although multiple communication busses or other communication channels, or any number of other types of components may be used. The CPU 112 and/or GPU 114 may generally include one or more processing components capable of executing computer-executable instructions received or stored by the system 100. For instance, the CPU 112 or GPU 114 may communicate with the input/output devices 116 using the communication bus 126. The input/output devices 116 may include ports (e.g., port 104 of FIG. 1A), buttons (e.g., buttons 106 of FIG. 1A), one or more displays 102, cameras 108, speakers 110, keyboards 128, microphones 130, lights 132, a mouse, scanners, printers, touch screens, global positioning system (GPS) units, audio mixing devices, sensors, other components, or any combination of the foregoing, at least some of which may provide input for processing by the CPU 112 or GPU 114, or be used to receive information output from the CPU 112 or GPU 114. Similarly, the network interface 118 may receive communications via a network (e.g., CDMA network, a GSM network, an LTE, HSPA+, 802.11, or other data network, a Bluetooth or near-field communication connection, a mesh network, etc.). Received data may be transmitted over the bus 126 and processed in whole or in part by the CPU 112 or GPU 114. Alternatively, data processed by the CPU 112 or GPU 114 may be transmitted over the bus 126 to the network interface 118 for communication to another device or component over a network or other communication channel.

The network interface 118 may include any number of components, including such components as discussed herein. Such components may include hardware, firmware, software, and any combination of the foregoing. For instance, antennas, chipsets, and the like may interact with software and/or drivers to allow or enable network communication to occur over a wired or wireless network. Example communication may therefore occur over hard-wired communication components and/or wireless communication components or interfaces such as may be used for USB, Firewire, WiFi (i.e., 802.11), Bluetooth, CDMA, LTE, GSM, HSPA+, Z-Wave, NFC, Zigbee, or other communications and protocols.

The system 100 may also include memory 120, a power supply 122 (e.g., a rechargeable battery), and mass storage 124. In general, the memory 120 may include both persistent and non-persistent storage, and in the illustrated embodiment the memory 120 is shown as including random access memory 134 and read only memory 136. Other types of memory or storage may also be included in memory 120.

The mass storage 124 may generally be comprised of persistent storage in a number of different forms. Such forms may include a hard drive, flash-based storage, optical storage devices, magnetic storage devices, or other forms which are either permanently or removably coupled to the system 100, or in any combination of the foregoing. In some embodiments, an operating system 138 defining the general operating functions of the portable electronic device 100, and which may be executed by the CPU 112 and/or GPU 114, may be stored in the mass storage 124. The operating system 138 may include any number of different operating systems currently available or which may be developed in the future. Non-limiting examples of operating systems 138 that may be used by the electronic device 100 may include open and closed source operating systems. Example operating systems may include operating systems provided by Google, Inc. under the ANDROID™ name, by Apple Inc. under the IOS™ or MAC OS® names, by Microsoft Corporation under the WINDOWS® or WINDOWS PHONE™ names, and by Research in Motion Limited under the BLACKBERRY OS™ name. Still other examples of operating systems suitable for use with the electronic device 100 may include operating systems provided under the LINUX®, QNX®, TIZEN™, and BADA™ names. Other example software, data, or other components stored in the mass storage 124 may include drivers (e.g., programs, code, or other modules including Kernel extensions, extensions, libraries, or sockets), browsers 140, application programs 142, and the like.

The application programs 142 may include other programs or applications that may be used in the operation of the portable electronic device 100. Examples of application programs may be essential applications run using or in conjunction with the operating system 138, including applications which may be provided by a manufacturer or software provider for the electronic device 100. Other applications, whether user-installed or provided by the manufacturer or other provider, may be non-essential for the operation of the electronic device 100.

Example applications that may be installed upon manufacture of the electronic device 100, or which may be after-market applications, may include an email application 144 capable of sending or receiving email or other messages over the network interface 118, a calendar application 146 for maintaining a record of a current or future data or time, or for storing appointments, tasks, important dates, etc., or virtually any other type of application. As will be appreciated by one of skill in the art in view of this disclosure, other types of applications 142 may provide other functions or capabilities, and may include word processing applications, spreadsheet applications, or other productivity software. Still other applications may include programming applications, computer games 148, audio or visual data manipulation programs, recording or playback applications, camera applications 150, mapping applications, contact information applications, or other applications. In at least one embodiment, the electronic device 100 may be used as a mobile phone, or smart phone, in which case a telephone application 152 may be used to facilitate such communications.

In embodiments disclosed herein, the application programs 124 may further include applications or modules capable of being used by the device 100 in connection with providing security to the portable electronic device 100. For instance, in one example, a security application 154 may monitor a connection maintained by the network interface 118 (or an ability of the network interface to make a connection) with a separate security device. As discussed in greater detail herein, the security application 154 may be used to place the electronic device 100 in an enabled or unlocked state while a particular communication link or connection is present or available. In contrast, when the connection becomes unavailable (e.g., by moving a wireless security device or electronic device so that the devices are out of range), the security application 154 may interact with other components disable, shut-down, lock, or otherwise restrict access to some or all applications 142, input-output devices 116, other features or components, or any combination thereof. While the security application 154 is illustrated separate from other applications 142, it should also be appreciated that such application can be included as part of such other applications 142, as part of the operating system 138, or as part of other components stored in storage 124, memory 120, or in other locations.

The electronic device 100 of FIGS. 1A and 1B is but one example of a suitable device or system that may be used as an electronic device that may be secured using embodiments of the present disclosure. In other embodiments, other types of systems, devices, applications, I/O components, communication components or the like may be included. Additionally, a security application 154 may be provided with, or given access to, additional or alternative modules or applications, which modules or applications may collectively provide a security interface for the electronic device 100.

One manner in which security may be provided to the electronic device 100 of FIGS. 1A and 1B is by using wireless communication with one or more other devices. In some embodiments, the portable electronic device 100 may be capable of carrying electronic communications through multiple simultaneous or asynchronous channels, sessions, or connections. The Internet, local area networks, wide area networks, virtual private networks (VPN), telephone networks, other communication networks or channels, or any combination of the forgoing. For instance, FIG. 1B illustrates an example electronic device 100 that includes a network interface 118 having at least two components, including a wireless component 156 and a wired component 158. The electronic device 100 may be capable of using the wireless 156 and wired 158 components independently to maintain different communications at the same or at different times. As discussed herein, example, non-limiting protocols that may be used for wireless communication using the wireless component 156 may include long or short-range protocols. Example wireless protocols include standard protocols such as WiFi (i.e., 802.11), Bluetooth, CDMA, LTE, GSM, HSPA+, Z-Wave, NFC, Zigbee, or other communications and protocols, or some combination of the foregoing. Thus, the wireless component 156 may itself be capable of carrying on multiple, simultaneous or asynchronous communication channels at a single time, with some or all channels using the same, or a different, protocol. Example standard protocols usable by the wired component 158 may include USB, Firewire, and the like, although other standard or proprietary protocols are contemplated.

One manner in which the electronic device 100 may be secured, and thus changed between enabled and disabled states, may include monitoring the connections available to, or maintained by, the network interface 118. As discussed in greater detail, a particular example may include the use of a wireless component 156 to monitor a wireless connection with another wireless electronic device. Optionally, the other wireless electronic device uses a short-range wireless communication protocol. Thus, if the two devices are separated by too large a distance, communication may be restricted or impossible. If communication is not available, the portable electronic device 100 (e.g.,, through the security application 154) may disable or otherwise lock the electronic device 100.

Turning now to FIGS. 2A and 2B, an example security device 200 is shown in additional detail. The security device 200 may, in some embodiments, be used to connect to an electronic device (e.g., electronic device 100 of FIG. 1A) to secure the electronic device. The wireless security device 200 may also be an electronic device. For purposes of this disclosure, however, the device that is being secured (e.g., electronic device 100 of FIG. 1A) may be referred to herein as an “electronic device” or “portable electronic device”, whereas the device used to determine whether the electronic device should be enabled or disabled (e.g., electronic device 200 of FIG. 2A) may be referred to as a “security device,” “wireless security device,” “security key”, or using other similar terminology.

The security device 200 of FIG. 2A is generally illustrated as a keychain device that may be connected to a set of keys, although such an embodiment is purely illustrative, and the security device 200 may have other structures, uses, and the like. The particular structure of the electronic device 200 can thus vary substantially to include any number of different configurations and uses.

FIG. 2A, for instance, illustrates the security device 200 as including a body 202 connected to a post 204. The post 204 and body 202 may cooperate to define a connector to which a set of keys 201 may be connected. In particular, in this embodiment, the post 204 may connect to the body 202 adjacent an opening 206. The opening 206 may provide a space into which a key ring of the keys 201 may be locate once the key ring is placed around the post 204. The post 204 may of course be eliminated and replaced with other components (e.g., a ring, an opening, etc.) to allow connection to a set of keys 201. Further, while the body 202 is generally rectangular in shape, the body 202 may have other shapes, including elliptical, circular, pentagonal, or other shapes, or any combination of the foregoing.

Use of the security device 200 as a key ring is merely illustrative. In other example embodiments the security device 200 may take other forms. For instance, the security device 200 may be a stand-alone device not intended for use with a set of keys. Instead, the stand-alone device may be carried in a pocket or wallet. In other embodiments, the security device 200 may include a flash drive (e.g., USB drive) to allow it to function both as a security device and as a memory device. In still other embodiments, the security device 200 may include a watch/wristband, a mobile phone, a pin, a pen, or some other device, or any combination thereof.

Regardless of the particular form factor and additional other uses (if any) of the security device 200, the security device 200 may include any number of features or components to allow it to be used as a security device in connection with an electronic device. FIG. 2B schematically illustrates some example components of one embodiment of a security device 200.

In some embodiments, the security device 200 may include similar components relative to the electronic device 100 of FIG. 1B. In other embodiments, however, the security device 200 may have more limited capabilities or functions. FIG. 2B illustrates the optional example of a security device 200 having potentially reduced functionality relative to the electronic device 100 of FIG. 1B.

In the illustrated example embodiment, the security device 200 may include one or more optional processors 212. Such processors 212 may be of any suitable type, and can include a CPU or GPU similar to those described previously, or may include chipsets or other processing components. The processors 212 may interface with one or more optional input/output (I/O) devices 216, a network interface 218, memory 220, a power supply 222, or other components. One manner in which communication may occur is using a communication bus 226, although multiple communication busses or other communication channels, or any number of other types of components may be used. The various components may include or be similar to other components available in an electronic device such as that described previously. Notably, however, one example embodiment includes a network interface 218 which may communicate over a communication protocol or network. In at least one example embodiment, network interface 218 can communicate with a corresponding network interface of a portable electronic device, such as to establish, maintain, check, identify, associate with, or otherwise determine or use a communication system to provide security-related features. In at least one embodiment, the network interface 218 may be paired-up (e.g., using a Bluetooth, NFC, or other short-range communication connection) with a network interface of a corresponding electronic device. The network interface 218 may therefore include any number of components, including hardware, firmware, software, and any combination of the foregoing. FIG. 2B, for instance, illustrates the network interface 218 as including a radio module 256 and antenna 258. Such components may be used to send and/or receive wireless signals and associate with an electronic device also including wireless capabilities. The security device 200 may also include memory 220 and/or a power supply 222 (e.g., a rechargeable battery) in some embodiments.

In general, the security device 200 may be used specifically to be paired with, or otherwise maintained in communication with, an electronic device. According to at least some embodiments, the electronic uses of the security device 200 may be dedicated primarily to provision of security related features (e.g., providing a monitored connection to allow an electronic device to lock itself when out of range of the security device 200). In such an embodiment, the security device 200 may include only, or primarily, the components for allowing such a connection to be established, maintained, and monitored. In other embodiments, however, the security device 200 may include additional, integrated features.

As an example, users of electronic devices with audio and/or video communication or output features may pair such devices with an earpiece. The earpiece can be connected using wires, or may be connected wirelessly (e.g., a Bluetooth earpiece). In accordance with some aspects of the present disclosure, the security device 200 could include other features, including data input and/or audio output features to allow receipt of audio data from an electronic device and playing of the audio data through an audio output. The earpiece could also, however, include components to allow the electronic device to monitor the connection with the earpiece. The security device 200 could also, or alternatively, provide other features in addition to mere security (e.g., data storage, ink/pen, time keeping capabilities, etc.).

While FIG. 2B illustrates an example embodiment of a security device 200 that includes a processor 212 and/or input/output devices 216, such an embodiment is merely illustrative. In one embodiment, for instance, the security device 200 used to communicate with an electronic device may be a “dumb” device lacking processing capabilities, or at least lacking significant capabilities separate from the network interface 218, or above those merely needed to establish and maintain a wireless connection. In the same or alternative embodiments, the security device 200 may include a processor 212 but may not include a display or other similar input/output components. Accordingly, in embodiments in which the security device 200 is used in a security system with an electronic device, the electronic device may include significant processing components while the security device 200 may lack similar capabilities. Such an embodiment may be provided in contrast to an embodiment in which an electronic computing device communicates with another electronic computing device, with each having significant processing and/or display components (e.g., tablet computing device, smart phone, wireless phone, laptop computer, e-reader, etc.).

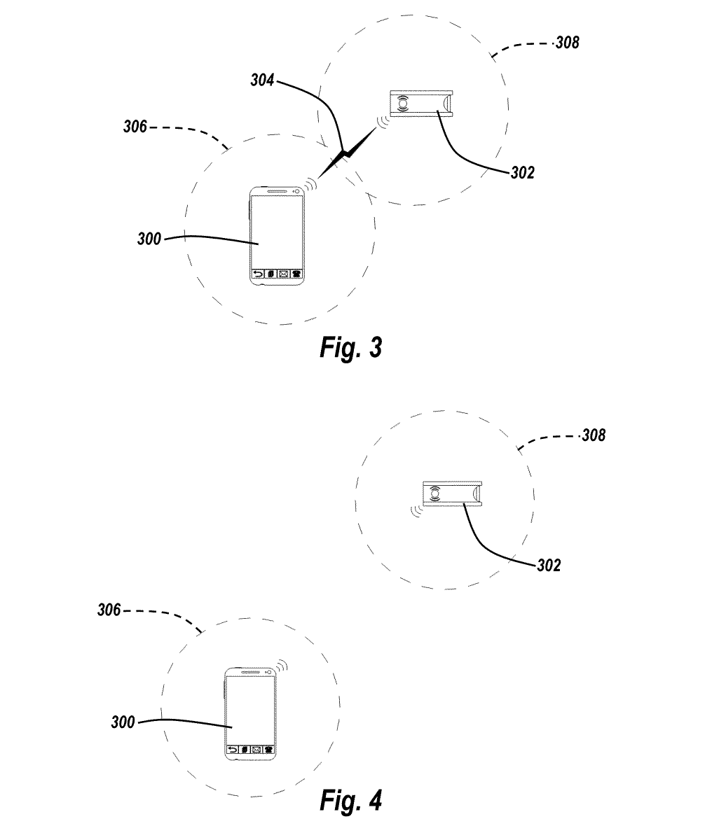

To better understand embodiments in which a security device (e.g., security device 200 of FIG. 2A) may be used in connection with an electronic device (e.g., electronic device 100 of FIG. 1A) to secure the electronic device against unauthorized or unwanted use, attention is now paid to FIGS. 3 and 4. FIGS. 3 and 4 represent embodiments of a security system in which an electronic device 300 and security device 302 may be paired together to secure the electronic device 300.

With particular reference to FIG. 3, the example electronic device 300 and security device 302 may take a number of forms, shapes, and configurations. Therefore, the illustrated construction of the electronic device 300 and the security device 302 are merely illustrative. In this embodiment, for instance, the security device 302 may be configured to act similar to a key ring as described relative to FIG. 2A. Thus, a user may easily carry the security device 302 in his or her pocket, purse, or bag along with the user's house keys, car keys, office keys, and the like. In other embodiments, the security device 302 may have other configurations. In some embodiments, the security device 302 can be a stand-alone security device primarily or solely dedicated to providing security-related features. In other embodiments, the security device 302 may be an integrated device providing security-related features in addition to providing other electronic capabilities (e.g., a watch, a phone, a wireless earpiece, etc.).

The security device 302 may be configured to communicate with the electronic device 300. In accordance with one embodiment, for instance, the electronic device 300 may include a network interface for wireless communication. Such interface may include antennas, processors, chipsets, software, firmware, or other components that allow the electronic device 300 to send and/or receive short, intermediate, or long-range communications, or some combination thereof. As discussed herein, the electronic device 300 optionally includes a network interface for multiple types of communication (including multiple types of wireless communication). Accordingly, in some embodiments, one type of wireless communication may be used to provide security-related features in connection with the security device 302, while another type of wireless or wired communication (or potentially a same type of wireless communication) may be used for data transmission using a communication network.

According to an embodiment of the present disclosure, the security device 302 may also be equipped with a network interface. The network interface of the security device 302 may be configured specifically, or generally, to allow communication with the electronic device 300. Thus, if the electronic device 300 includes a network interface for one type of communication (e.g., Bluetooth, Z-Wave, Zigbee, NFC, WiFi, etc.), a corresponding network interface of the security device 302 may provide for a corresponding type of communication. As shown in FIG. 2, the wireless communication capabilities of the electronic device 300 and security device 302 may allow an electronic or communicative connection 304 to be maintained therebetween.

The connection 304 may be enabled or disabled based on various factors. For instance, a user of the electronic device 300 may disable a type of communication protocol, or the user may disable the communication of the security device 302. For instance, if the electronic device includes Bluetooth, WiFi, or other similar wireless capabilities, a corresponding Bluetooth, WiFi, or other radio component may be turned off. Alternatively, rather than affirmatively disabling the communication systems, the electronic device 300 or security device 302 may be powered down or may lack sufficient power to maintain the communication connection 304. In still other embodiments, the electronic device 300 and security device 302 may each continue to operate a respective network interface, but the connection may fail. Such failure may be the result of environmental conditions (e.g., RF interference, walls, etc.), or other factors, including the range associated with the network interface components (see FIG. 4).

More particularly, an example wireless range 306 associated with the antenna or other components of the electronic device 300 is shown in FIG. 3. The wireless range 306 is generally shown as circular and omni-directional, although the range could have any associated property, and may be directional in some embodiments. A wireless range 308 of the security device 302 is also shown in FIG. 3. The wireless range 308 is also shown as being circular and omni-directional, and generally has a same size as the range 306, although the range associated with each device 300, 302 could be different in terms of size, direction, or other feature (e.g., due to power capabilities, antenna type, etc.).

As the electronic device 300 and/or security device 302 is moved around, the devices 300, 302 may be moved further apart or closer together. When the devices 300, 302 are drawn sufficiently close to each other that the ranges 306, 308 overlap (see FIG. 3), the security system may be able to maintain the connection 304. If, however, the devices 300, 302 are moved sufficiently far apart so that the ranges 306, 308 do not overlap (see FIG. 4), no connection 304 may be present. As discussed in more detail herein, the state of the electronic device 300 can be affected based on the connection status between the devices 300, 302. For instance, when the devices 300, 302 are unable to initiate or maintain the connection 304, the electronic device 300 can be fully or partially locked or disabled. The electronic device 300 may therefore be secured in some embodiments based on the proximity of the electronic device 300 relative to the security device 302. Proximity may be measured by the ability of the electronic device 300 to maintain the connection 304 with the security device 302.

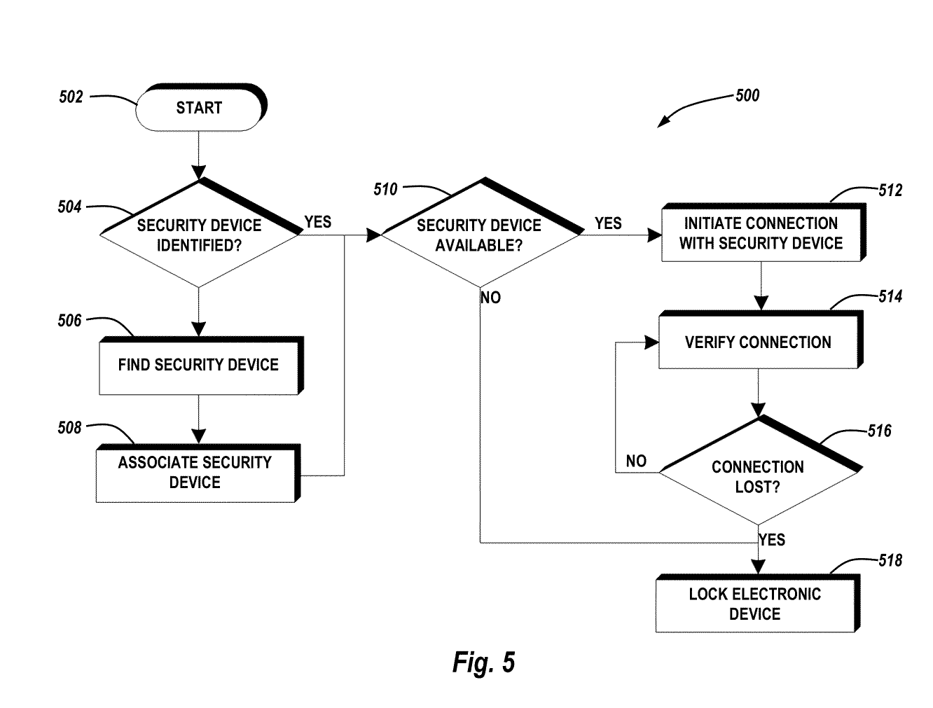

An example method 500 for securing an electronic device in accordance with certain embodiments of the present disclosure is shown in FIG. 5. In particular, the method 500 may begin at act 502. Beginning the method in act 502 may occur in any manner, including upon powering up an electronic device, turning on a security application, enabling or disabling a wireless radio, or in other manners. The illustrated method 500 may be performed by an electronic device (e.g., portable electronic device 100 of FIG. 1A). As an example, computer-executable instructions stored in software on, or accessible to, the electronic device, or on firmware, may be executed by one or more processors to cause the electronic device to perform the method 500. Such method 500 therefore be performed using any combination of software, firmware, and hardware.

In the illustrated method 500, upon starting the method in act 502, an application, process, or other component of the electronic device may attempt to determine if a security device has been identified for association with security-related features (act 504). If no device has been identified, the method 500 may then include an additional act 506 of finding a security device to associate with the security-related features. Such an act 506 may occur in any number of manners. For instance, a wireless radio may be turned on and a scan performed to identify security devices within range of the electronic device. By way of illustration, each of the electronic device and security device may have network interfaces to allow a wireless or other electrical/communicative connection to be established therebetween. The electronic device may send beacon messages or otherwise use its network interface to attempt to find the security device. Of course, rather than performing a scan, finding an electronic device in act 506 may include receiving specific user input identifying a security device. Examples of information that may be entered include address information (e.g., MAC address), device name information, or other identification information, or any combination thereof. Once one or more security devices are found in act 506, the security devices may be associated with the security application, or other program or features, of the electronic device in act 508. Associating the security device in act 508 can include storing on the electronic device identification information of the security device and associating the stored information with a security application or other component of the electronic device.

Upon identifying and/or associating the security device associated with the security-related features of the electronic device (acts 504, 508), the method 500 may continue by determining whether the security device is currently available in act 510. Determining in act 510 whether the security device can be found may include using the network interface of the electronic device and attempting to discover or see the security device. If the security device is found in act 510, the security device may be considered available, and a connection may optionally be established in act 512. If, however, the security device is not found or available in act 510, or if no connection can be initiated or established, the electronic device may be locked in act 518. Locking the electronic device in act 518 may include limiting the functionality of one or more features of the electronic device. Features that are locked or limited may include software and/or hardware features. For instance, locking the device may include limiting access to certain software features by requiring a user to enter an unlock code to interact with some or all software or hardware components. Of course, rather than an unlock code, other options may potentially be used to override the lock (e.g., facial recognition, biometric readers, etc.).

Returning to act 512 and establishing of a connection between the security device and the electronic device, the electronic device may then verify the connection in act 514. Verifying the connection in act 514 may include maintaining a constant connection and detecting when the connection is lost. Alternatively, verifying the connection may be intermittent. For instance, the electronic device may terminate a connection and occasionally attempt to find (act 510) and reconnect (act 512) to the security device. Alternatively, the electronic device may not connect, but may instead perform a scan or other search to determine whether the security device can still be seen or is discoverable. Regardless of how verification is performed in act 514, the electronic device may determine whether or not the connection, the ability to establish a connection, or the presence of the electronic device has been lost in act 516. If the ability has been lost, the electronic device may be locked in act 518. Alternatively, if the connection has not been lost, the electronic device may continue to verify the connection in act 514.

The method 500 of FIG. 5 may be used by an electronic device as a security measure. In one embodiment, the method 500 may be used to ensure that if a portable electronic device is inadvertently misplaced, someone finding the portable electronic device cannot use the device in an undesired manner. For instance, as discussed previously, a portable electronic device may be within a wireless communication range of a security device (see FIG. 3). The security device may be paired with or otherwise identified by the portable electronic device, particularly for security. When the security device and portable electronic device are in range of each other, the portable electronic device can determine that the user has possession of both the portable electronic device and the security device, and thus that access to the portable electronic device should be granted.

The user may also, however, forget his or her portable electronic device. In such a case, the user may carry the security device out of range of the electronic device (see FIG. 4). As discussed with respect to FIG. 4, when such an event happens, the software, firmware, hardware, or other components of the portable electronic device may be used to lock the device. IN particular, the device may determine that no connection can be made, which can indicate that there is too large a distance between the portable electronic device and the security device. In such a case, the portable electronic device may be automatically disabled or locked down. Locking the portable electronic device in this manner may prevent a person finding the portable electronic device from accessing personal or other information on the device, using the device in an undesired manner, etc. Accordingly, if a user forgets his or her portable electronic device, such that the portable electronic device and security device go out of range of each other, use or access of the portable electronic device can be limited.

A similar effect may occur if the user forgets or leaves the security device but continues to carry the electronic device. In such a scenario, the electronic device and security device may again be separated so that a connection cannot be established. In such a case, the electronic device may again be automatically locked. As the user continues to carry the electronic device, however, the user can manually or otherwise unlock the phone (e.g., using a PIN, password, or other mechanism). Optionally, the user may then also disable the security application or feature until the user finds the security device or can pair a new security device with the electronic device.

While the method 500 may be used in connection with a portable electronic device, it should be appreciated that the method 500 may also be used in a broader context, including with electronic devices that are not particularly portable. For instance, a desktop computing device may include a network interface for connecting to a security device. The security device may be associated with a particular user. If a user does not have his or her security device, the desktop computing device may be unable to identify the security device, and can restrict some or all access to the electronic device. Optionally, an administrative account or password, or other override feature may be used to enable access without the security device, although in other embodiments the security device may be required to obtain full access to the electronic device.

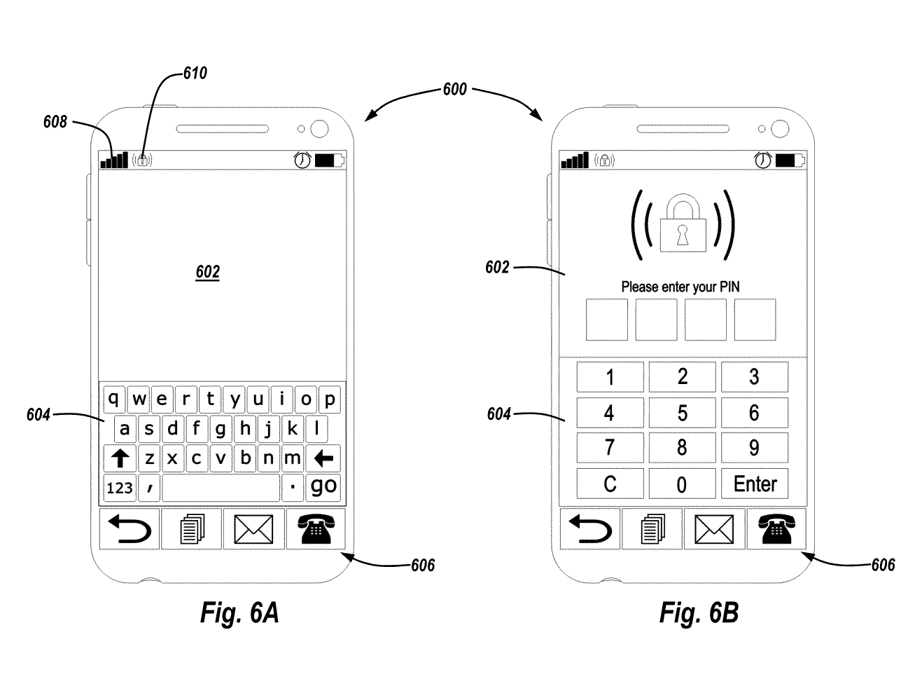

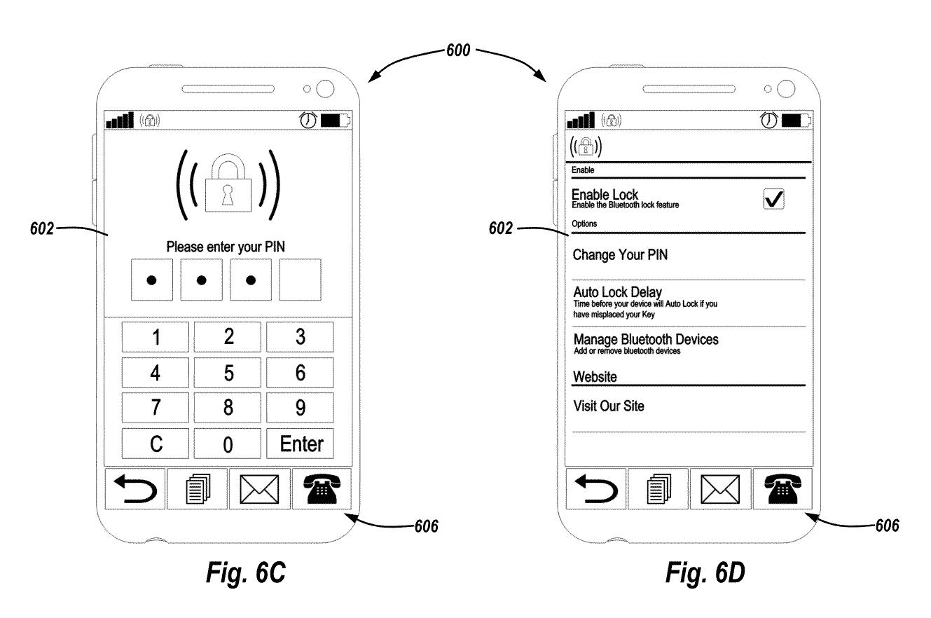

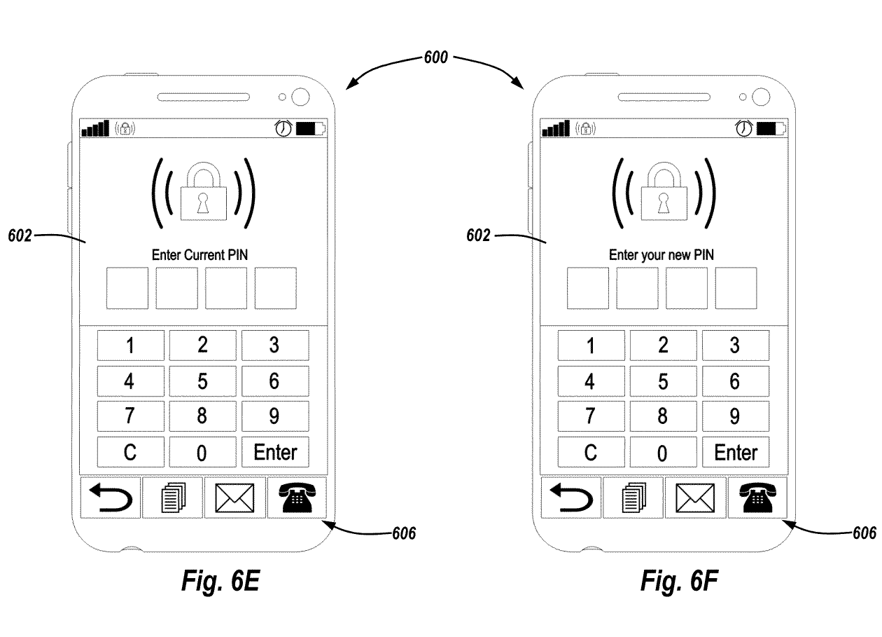

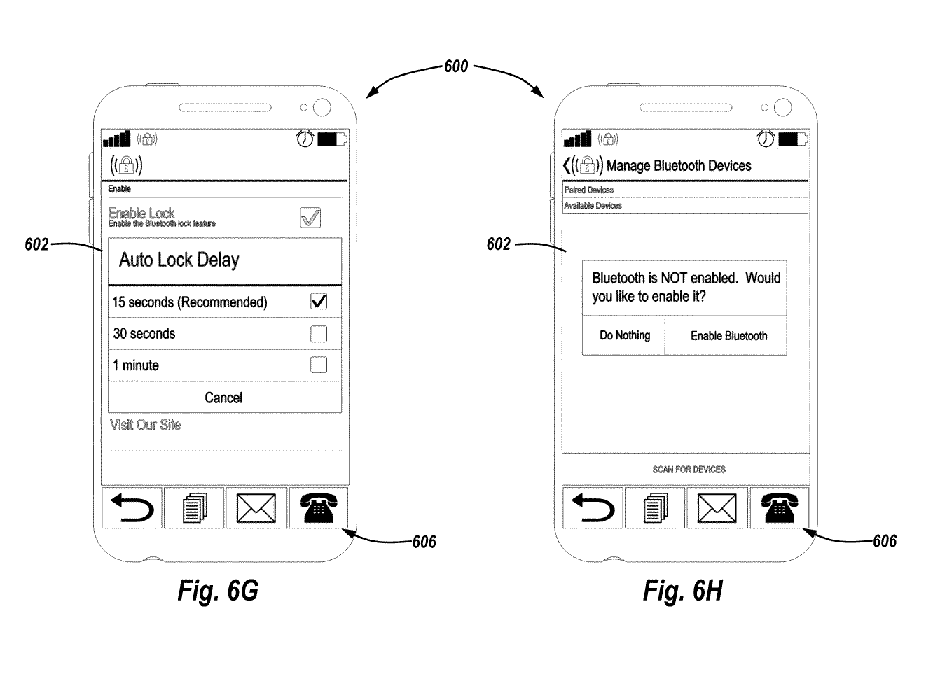

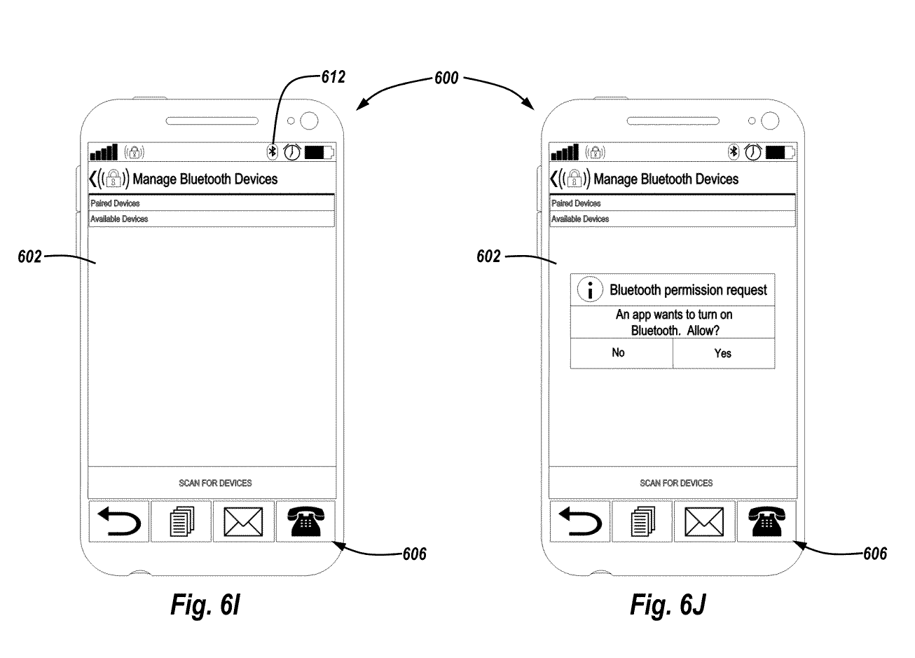

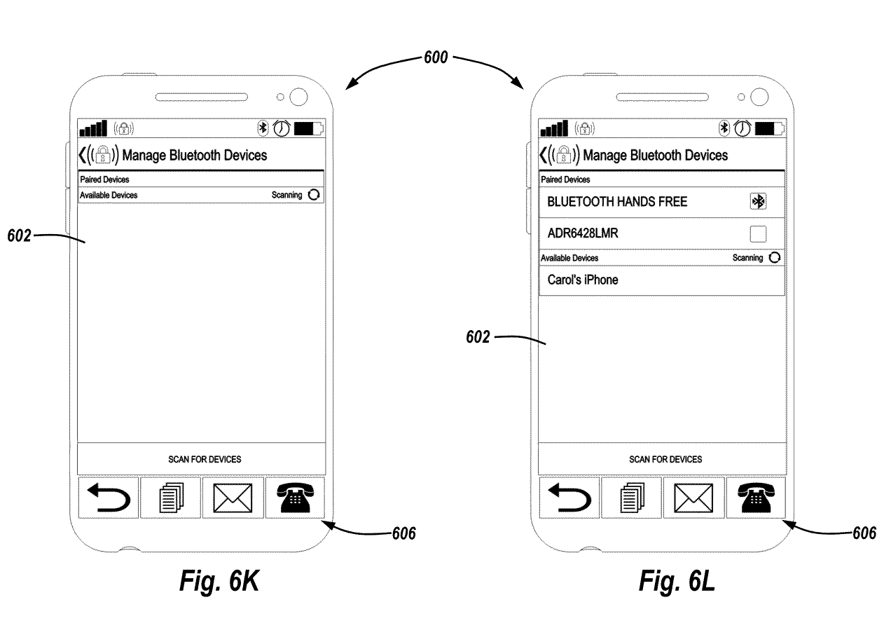

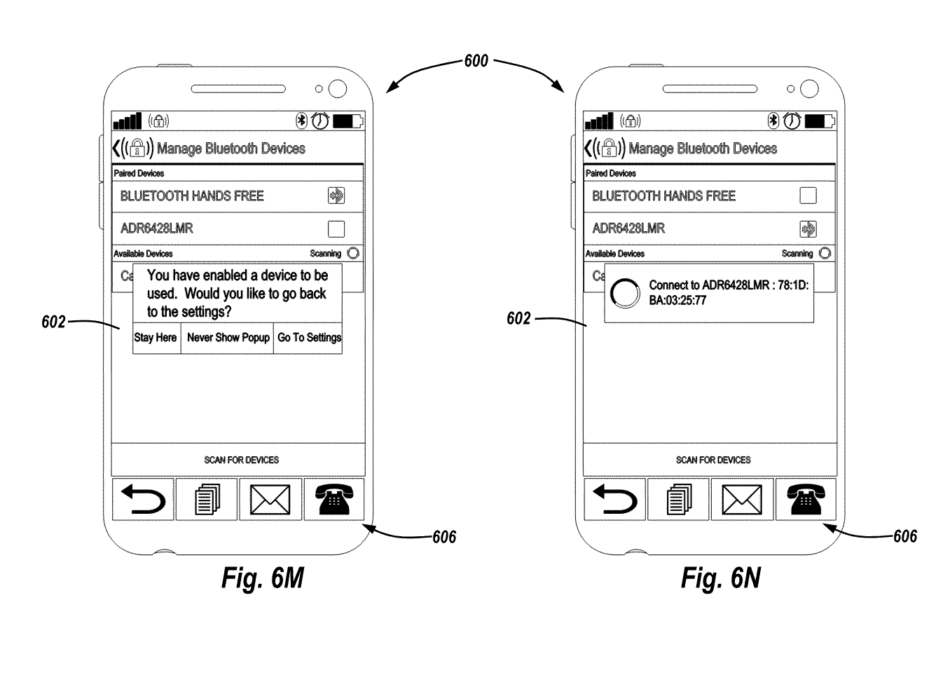

Turning now to FIGS. 6A-6N, an example electronic device 600 is illustrated. The electronic device 600 may include a security application usable to set-up and execute security-related features on the electronic device 600. In at least some embodiments, the electronic device 600 may be used to perform the method of FIG. 5, or another method to identify a security device, check for a connection or availability of a security device, and/or lock the electronic device when a security device cannot be found, or when a connection cannot be made.

More particularly, FIG. 6A illustrates the example electronic device 600 in an enabled state, whereas FIG. 6B illustrates the same electronic device 600 in at least one example of a disabled or locked state. In general, when the electronic device 600 is in the accessible state of FIG. 6A, one or more features or options may be available to a user, whereas in the disabled state of FIG. 6B, one or more features or options may be shut-down, locked, or otherwise inaccessible. In some embodiments, the disabled state illustrated in FIG. 6B may be triggered upon initializing or accessing a security application, so that further access to the security application is disabled unless a user provides proper authentication credentials. In other embodiments, the disabled state shown in FIG. 6B may indicate that other options, and potentially all or most options, of the electronic device 600 are shut down (e.g., in response to detecting a security device is out of range or not communicating with the electronic device).

More particularly, FIG. 6A illustrates the example electronic device 600 as having a configuration similar to that of a “smart phone” device; however, as discussed herein such an embodiment is merely illustrative. In this embodiment, the electronic device 600 may include various features, including a display 602, a keyboard 604, and a set of one or more input buttons 606. The keyboard 604 may be a physical keyboard or a virtual keyboard. A physical keyboard may be attached to, or integral with, the electronic device 600 and may include physical keys. If the keyboard 604 is a physical keyboard, the input buttons 606 are optionally, but not necessarily, included as part of the keyboard 604. Rather than having physical keys, a virtual keyboard may be displayed on all or a portion of the display 602. In this embodiment, the illustrated keyboard 604 may be a virtual keyboard presented on a touch-screen display 602. Optionally, the input buttons 606 may also be virtual buttons on the display 602.

The electronic device 600 may be able to obtain information from local or remote sources. For instance, as discussed in greater detail herein, the electronic device 600 may include memory or physical storage on which some data is stored. In the same or other embodiments, a network interface may use wireless protocols (e.g., Bluetooth, WiFi, LTE, CDMA, GSM, HSPA+, NFC, Z-Wave, Zigbee, etc.) or wired protocols (e.g., serial, USB, proprietary protocols, etc.) to access data or communicate with other devices or systems. The illustrated electronic device 600 optionally displays the status of all or some components capable of establishing a connection. As shown in FIG. 6A, for instance, a wireless signal strength 608 may be included to indicate the strength of a signal with a cellular or other mobile network. A further indicator 610 is also shown. The indicator 610 may be used, in this embodiment, to visually depict when a security-related application is running on the electronic device 600. In some embodiments, the security-related application may selectively lock the electronic device 600 based on a connection to a wireless security device (e.g., using Bluetooth) as discussed in connection with some embodiments disclosed herein.

The indicators 608, 610 are purely optional, and other embodiments contemplate maintaining and/or establishing a connection, or activating an application, without displaying a visible indicator presented to the user. Optionally, the indicator 610 may also change based on a status of the electronic device. For instance, the image (e.g., a lock) may change based on whether the electronic device 600 is connected or disconnected relative to a security device (e.g., a closed lock to show a locked device when a connection is not available to the security device, or an open lock to show an enabled device when a connection to a security device is available). In other embodiments, colors of the indicator 610 may change (e.g., red to show a locked state, green/blue to show an enabled state, etc.). In some embodiments, changes to the indicator 610 may additionally, or alternatively, be based on a status of a network interface. For instance, if the security application is running but a wireless radio is disabled, the indicator 610 may include one color or image (e.g., an image lacking wireless symbols) as compared to when the wireless radio is enabled. The indicator 610 may thus provide a visual indication of status of a security application and/or device to quickly view the device status. In at least some embodiments, it may be configurable using the security application as to whether to display the indicator 610, or when to display the indicator.

As discussed herein, some embodiments of the present disclosure contemplate locking or otherwise disabling all or a portion of the electronic device 600 when the security application on the electronic device 600 is accessed and/or when the electronic device 600 is unable to connect to, or find, a particular security device. FIG. 6B illustrates an example interface that may be presented on the display 602 when the electronic device 600 is disabled, locked, or otherwise inaccessible. In some embodiments, a user may be able to type or input a code on the display 602, and when that code is authenticated, the electronic device 600 may give the user the ability to change the settings within the security application on the electronic device 600. FIG. 6C, for instance, illustrates an example embodiment in which a security code is being input using a virtual keypad displayed on the display 602.

In some embodiments, the interface displayed in FIGS. 6B and 6C may be specific to a security application run by the electronic device 600. In such an embodiment, the interface may be provided to restrict access to disable or change settings of the security application, unless authentication occurs. In other embodiments, the interface may be specific to the security application, and can be used to lock some or all access to the electronic device 600. For instance, upon detecting that a security device is out-of-range, the interface of FIGS. 6B and 6C may be displayed to restrict some or all access to the electronic device 600.

In other embodiments, the electronic device 600 may use or trigger display of multiple interfaces. For instance, the interface of FIGS. 6B and 6C may be a lock screen for restricting access to the security application, whereas a different lock screen may be provided when the electronic device 600 is locked (e.g., due to lack of communication with a security device). In one embodiment, using multiple lock screens may reduce the likelihood that a person without authorization accesses and disables the electronic device 600. For instance, if an unauthorized person accesses the phone while still in range of a security device, the lock screen of FIGS. 6B and 6C may limit the person's ability to open and disable the security application. Thus, the interface of FIGS. 6B and 6C may be presented each time the security application is accessed.

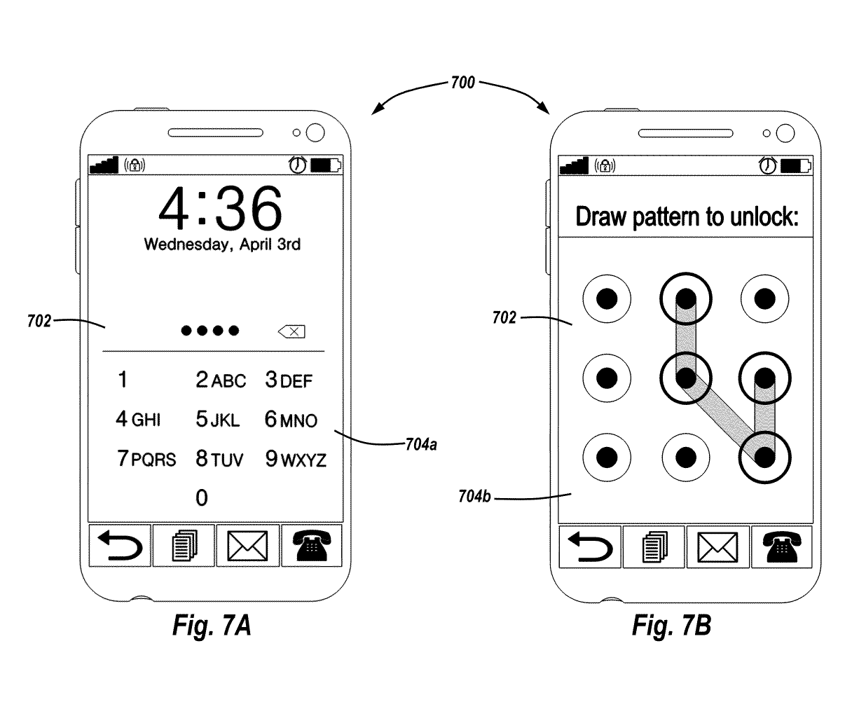

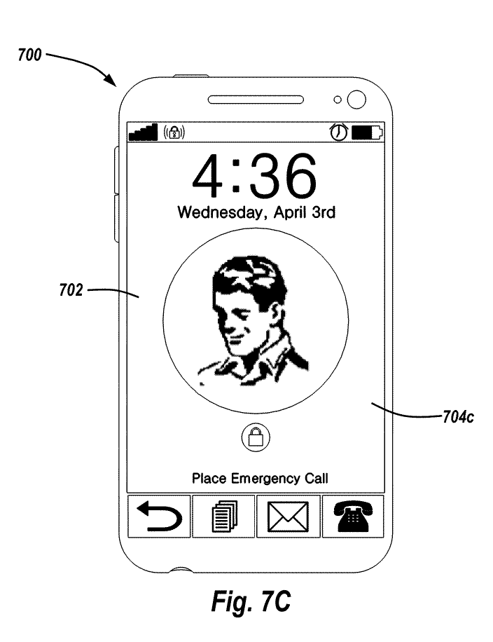

In some embodiments, the lock screen or other similar interface generated in response to an inability to communicate with a wireless security device may be a standard or built-in interface. For instance, the operating system of the electronic device 600 may include a built-in lock screen, and a security application may trigger display of the lock screen of the operating system. In some embodiments, the operating system or other software of the electronic device 600 may include multiple potential lock screen interfaces. A user may, for instance, choose whether to unlock the device using a PIN, a pattern recognition routine, a facial recognition, feature, or some other authentication methods. Turning briefly to FIGS. 7A-7C, examples of various interfaces 704a-704c are shown. These interfaces 704a illustrate lock-screens that may be native to the operating system or other components of the electronic device 700, and which may be triggered by the security application executing on the electronic device 700. In such embodiments, a user may use a touch screen component of a display 702 to enter a PIN into the interface 704a of FIG. 7A. In other embodiments, if a user has set-up the electronic device to require input of a particular pattern, an interface such as interface 704b of FIG. 7B may be used. Of course, using a camera or other input component, a user who has selected a facial recognition unlock feature may use an interface similar to interface 704c of FIG. 7C to unlock the electronic device 700 following locking in response to lost communication with a security device as described herein.

While FIGS. 7A-7C are described in terms of using a native lock-screen or interface of the electronic device, rather than a custom interface specific to the electronic device, other embodiments contemplate using an interface specific to the security application. Accordingly, a proprietary or other security-application specific interface may also use a PIN, pattern detection, facial recognition, or other authentication method.

Returning now to FIGS. 6A-6N, the operation of a particular example of a security application are described in additional detail. It should be appreciated, however, that such aspects and features are merely illustrative, and other embodiments may include additional or other features, different arrangements of features, and the like.

FIG. 6D illustrates an electronic device 600 when a display 602 displays a main or settings interface of a security application. As discussed herein, to access the settings interface, a user optionally may be required to authenticate himself or herself (e.g., using the interface of FIGS. 6B and 6C). Once access to the main or settings interface is granted, any number of settings related to the electronic device 600 may be set or viewed. For instance, in this embodiment, a user may be able to select whether or not the security application is active (e.g., by checking or unchecking the “Enable Lock” option. When enabled, the security application may be used to interact with a network interface to detect the presence of a security device. When disabled, the security application may not actively monitor the presence of a security device and/or may not selectively disable the electronic device 600 when the security device is not detected or connected.

Another option provided by a security application interface may include the ability to change a security code. FIG. 6D, for instance, illustrates that a user may change a personal identification number or PIN. Such a code may be specific to the security application or to the electronic device 600. For instance, upon changing the PIN or other code, the security application may direct a user to change a code set within the operating system settings of the electronic device 600. In other embodiments, however, the operating system and security application may include different security codes or features (e.g., patterns, facial recognition, etc.).

If the user selects the option in FIG. 6D for changing the PIN or other code (e.g., by tapping on the option where the display 602 is a touch-screen display), a corresponding interface may be provided to allow a user to select a new code. FIGS. 6E and 6F illustrate examples of such an interface. In particular, FIG. 6E illustrates an interface on the display 602 that allows a user to change a PIN or other code by first entering a current PIN or other code. Such a code may be entered by, for instance, typing the code using a virtual numeric or alphanumeric keypad displayed on the display. As noted herein, the code could, of course, include other features, including facial recognition, pattern recognition, or other features that may also be entered as part of the current code. Upon entering the current code, and potentially after verifying the correctness of the code, the user may then be prompted via an interface such as that shown in FIG. 6F to select a new PIN or other security code. As with the then current code, a new code may include numbers, letters, symbols, facial recognition features, pattern recognition components, or any other component usable as a security code.

Returning briefly to FIG. 6D, another option that may be provided via a security application may be the ability to adjust a delay associated with a lock feature provided by the security application. Such a feature may be used, for instance, to set how often the electronic application 600 verifies that a connection to a security device is available, or that the security device is present. FIG. 6G illustrates one example of an interface through which the delay may be set. In particular, a window may be displayed to request information on the delay. In this particular embodiment, options may be provided to select between a delay of fifteen seconds, thirty seconds, or one minute. Of course, the delay could be otherwise adjusted and other options may by provided that are shorter than fifteen seconds, longer than one minute, or are somewhere therebetween. In at least some embodiments, the delay may be user-defined. For instance rather than providing only predetermined options as shown in FIG. 6G (e.g., through check boxes, drop down lists, etc.), an input field may be provided to allow user to specify what delay timer should be used in checking for a connection with a security device.

FIG. 6D further shows an example interface that allows a user to manage what one or more wireless security devices may be associated with the security application. Upon selecting such an option, the interface may provide management options. FIGS. 6H-6N illustrate an example interface displayed on the display 602, and through which such management options may be set or viewed.

In one embodiment, upon selecting the option to manage wireless security devices, the application may check to determine whether or not a wireless radio used for security-related purposes is enabled. In this particular embodiment, for instance, a determination may be made that a particular wireless radio (e.g., Bluetooth) is used for security-related features, but that the radio is currently disabled. In that case, the interface on the display 602 may display a window, notice, or other option to notify the user that the radio is disabled. FIG. 6H illustrates an example window which not only may notify the user that the radio or feature is not enabled, but which may also be used to enable the radio. By selecting the option to enable the radio, the particular wireless component of a network interface used to communicate with the security device may be enabled. As shown in FIG. 6H, the particular component used in this embodiment may include a Bluetooth radio; however, other embodiments may use radios, chipsets, antennas, or other interfaces or components associated with other communication protocols. Optionally, when the communication component is enabled, an indicator 612 may be displayed on the display 602 to visually depict that the wireless radio component has been enabled (see FIG. 6I which shows a particular example for a Bluetooth radio component).

In some embodiments, any of multiple different wireless communication components may be used with one or more security devices. In that embodiment, determinations may be made as to whether any or all such communication components are available. If none are available, or if only some are enabled, an interface similar to that in FIG. 6H may be presented for some or all available communication components. Accordingly, a user may be able to choose whether to use, in one embodiment, any or all of Bluetooth, WiFi, or NFC for one or more security devices. Other embodiments may allow use with the same or other communication protocols, including Zigbee, Z-Wave, and the like.

In some embodiments, after a particular wireless component is determined to be enabled, an interface such as that shown in FIG. 6I may be used to manage the security devices that can connect to the electronic device 600. In FIG. 6I, for instance, no devices are currently listed as either already associated, or paired with the device, or as available to be paired. A further option may be presented to scan for, or find, available devices. When selected, the electronic device 600 may then use a wireless component (e.g., Bluetooth radio, antenna, and chipset) to search for potential security devices. In some embodiments, and as shown in FIG. 6J, the electronic device 600 may request permission to use the wireless component. Such permission may be requested or confirmed through the security application, although in other embodiments the operating system of the electronic device 600 may request confirmation that the finding or scanning feature should be allowed. As shown in FIG. 6K, once permission is granted, the interface on the display 602 may indicate that scanning is occurring to find potentially available devices. Once found, a security device may be selected and paired with the security application for use to enable security-related features.

FIG. 6L illustrates an example interface provided by a security application following association of one or more security devices with the electronic device 600. More particularly, FIG. 6L illustrates an example where two devices have already been paired, or associated, with the security application. Devices already associated include devices identified as “Bluetooth Hands Free” and “ADR6428LMR). A third device, namely “Carol's iPhone” has also been found and identified using a scanning feature.

In this particular embodiment, one device (i.e., the “Bluetooth Hands Free” device) has been selected for use as a security device. When selected, the security application may use the security device to selectively enable and disable features of the electronic device 600. For instance, as discussed herein, the proximity (as determined by the ability to connect to, or find, the security device) may be used to lock some or all features of the electronic device 600. While a single security device is shown as selected in FIG. 6L, some embodiments contemplate the ability to select multiple security devices for use simultaneously.

A device selected for use as a security device may be selected from a pre-existing list (e.g., a list of previously paired devices) or from a dynamically presented list (e.g., a list of currently available but unpaired devices). When a device is selected from either list, or from another location, the user may be given a notice that the device is being paired, or enabled, to work as a security device as shown in FIG. 6M. In this specific embodiment, the displayed interface may also allow a user to remain on the interface for managing the devices, or to return to a main settings page (see FIG. 6D). In another embodiment, confirmations of selected connections may be disabled (e.g., by selecting a “Never Show Popup” option). Particularly in embodiments in which a new security device is paired with the electronic device 600, a message may also be displayed, such as shown in the popup of FIG. 6N to indicate that a connection is actively occurring. Upon connecting to the security device, the electronic device 600 may be actively used to monitor a communication session. If the communication session is interrupted, the security application may lock the security device 600 as discussed herein.

To find and associate with potential security devices, the security application on the electronic device 600 may use any number of features or aspects. In some embodiments, any device at all capable of connecting via a particular wireless communication interface may be used. Thus, in an example of using a Bluetooth connection, if another electronic device (e.g., smart phone, tablet computing device, wireless earpiece, etc.) uses Bluetooth, that device may be used as a security device. Standard Bluetooth communication stacks, chipsets, and protocols may be used to identify a MAC address or other identification of the device, and thereafter maintain a connection with the electronic device 600.

Other embodiments may contemplate use of a dedicated security-related device with the security application. A dedicated security-related device may have potentially limited, or no, other components for providing other capabilities. In other embodiments, a particular security-component may be required for a security device, whether a general purpose device or a dedicated security-related device. For instance, continuing the example of a connection using Bluetooth, some embodiments may require an additional security feature (e.g., a MAC address within a particular range, an identifiable security component, etc.) beyond a simple Bluetooth connection. Thus, a Bluetooth device without a security component or feature may not be usable in some embodiments of a security application. In other embodiments, the requirement of a security component may be omitted.

Regardless of the particular type of security-related device, when a connection between the electronic device and the security-related device is lost or unavailable, the security application described herein may lock some or all features of the electronic device. This may include, for instance, displaying a lock screen requiring the user to authenticate himself or herself. As discussed herein, the authentication may take any number of forms, and can include entering of symbols (e.g., numbers, letters, characters, etc.), patterns, facial recognition components, or other security codes. An interface for receiving the security code for authentication purposes may include an interface native to the security application (see FIGS. 6B and 6C). In other embodiments, the interface for receiving the security code for authentication purposes may be native to the electronic device, an operating system of the electronic device, a software build of the electronic device, or the like (see FIGS. 7A-7C). In such an embodiment, the security application may trigger the native interface rather than displaying its own interface.

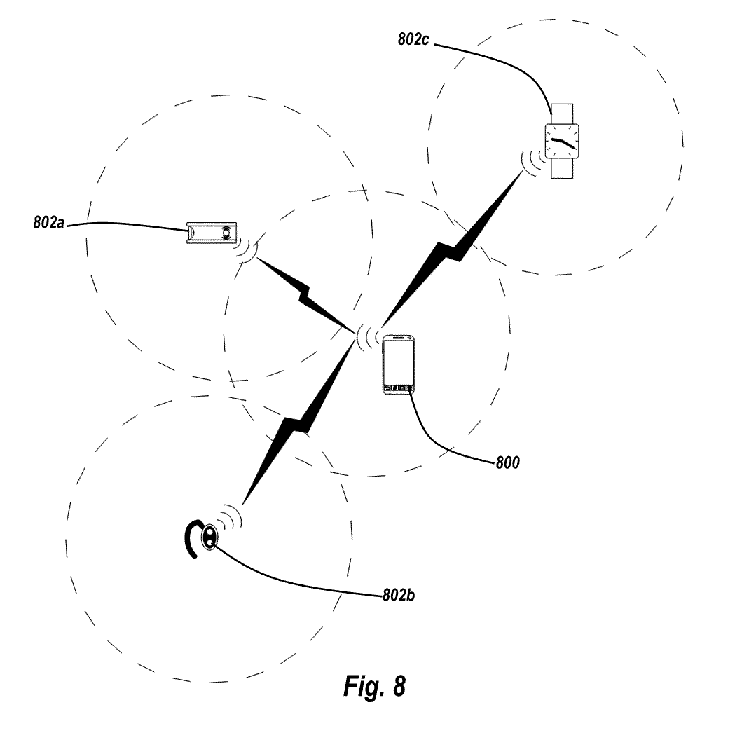

As will be appreciated in view of the disclosure herein, a user may have a single electronic device, or the user may have multiple electronic devices. Optionally, the user can have a different security device to secure each electronic device. In other embodiments, however, a single security device may be paired or otherwise associated with multiple electronic devices. In other embodiments, only a single security device may be used with a particular electronic device, although in other embodiments any or all of multiple security devices may be used with a single electronic device. FIG. 8, for instance, illustrates an example security system in which there are multiple available security devices 802a-802c that may be paired with a single electronic device 800.

The electronic device 800 and each security device 802a-802c may have a wireless or other network interface, with each having a particular range. When security devices 702a-702c are within range of the electronic device 800, a corresponding connection can be established. Such a connection may, as discussed herein, allow the electronic device 800 to determine that the authorized user is likely in possession of the electronic device due to the connection with a previously identified security device 802a-802c. If one or more of the security devices 802a-802c moves relative to the electronic device 800, and goes out-of-range (either by moving the electronic device, the security device, or both), the lost, moved, or otherwise displaced electronic device 800 may be automatically shut down, locked, or fully or partially disabled as discussed herein.

As one skilled in the art will appreciate in view of the disclosure herein, security aspects of embodiments of the present disclosure may be implemented automatically by using a security device separate from an electronic device. For instance, software (e.g., part of the operating system or separate therefrom) may be integrated and pre-loaded or installed as an after-market application on an portable electronic device. The software may run in the background and monitor the connection between the electronic device and the security device. Such monitoring may include attempting to maintain a constant connection, or checking at regular or irregular intervals to see if the connection can be made. Based on the ability to maintain or establish a connection, the background application may disable or lock the device (e.g., when the security device is out of range). Such a feature may disable all or some features of the electronic device. The security device may be a general purpose or other device which has a generally available wireless communication component (e.g., a Bluetooth radio, chipset, antenna, etc.). In other embodiments, the electronic device may additionally, or alternatively, require a software, data, or hardware component specific to the security application be located on the security device for use with embodiments disclosed herein. Accordingly, as shown in FIG. 7, example security devices may include multi-purpose devices such as wireless earpiece 702b and watch 702c. In other embodiments, however, the security device may be dedicated primarily for electronic use as a security-related component (e.g., security device 702a). A dedicated security device, such as security device 702a, may have any specific construction, and can be a key chain as discussed herein. In other embodiments, the security device 702a may have other structures, including as a pen, jewelry component (e.g., pendant, bracelet, brooch, etc.), pin, wristband, or the like.

Embodiments of the present disclosure may generally be performed by a computing device, and more particularly performed in response to instructions provided by an application executing on the computing device. In other embodiments, hardware, firmware, software, or any combination of the foregoing may be used in directing the operation of a computing device or system.

Embodiments of the present disclosure may thus comprise or utilize a special purpose or general-purpose computer including computer hardware, such as, for example, one or more processors and system memory, as discussed in greater detail herein. Embodiments within the scope of the present disclosure also include physical and other computer-readable media for carrying or storing computer-executable instructions and/or data structures, including applications, tables, or other modules used to execute particular functions or direct selection or execution of other modules. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media, including at least computer storage media and/or transmission media.

Examples of computer storage media include RAM, ROM, EEPROM, CD-ROM or other optical disk storage, magnetic disk storage or other magnetic storage devices, or any other non-transmission medium which can be used to store desired program code means in the form of computer-executable instructions or data structures and which can be accessed by a general purpose or special purpose computer.

A “communication network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmissions media can include a communication network and/or data links, carrier waves, wireless signals, and the like, which can be used to carry desired program or template code means or instructions in the form of computer-executable instructions or data structures and which can be accessed by a general purpose or special purpose computer. Combinations of physical storage media and transmission media should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above, nor performance of the described acts or steps by the components described above. Rather, the described features and acts are disclosed as example forms of implementing the claims.

Those skilled in the art will appreciate that the embodiments may be practiced in network computing environments with many types of computer system configurations, including, personal computers, desktop computers, laptop computers, message processors, hand-held devices, programmable logic machines, multi-processor systems, microprocessor-based or programmable consumer electronics, network PCs, tablet computing devices, minicomputers, mainframe computers, mobile telephones, PDAs, servers, and the like.

Embodiments may also be practiced in distributed system environments where local and remote computer systems, which are linked (either by hardwired data links, wireless data links, or by a combination of hardwired and wireless data links) through a network, both perform tasks. In a distributed computing environment, program modules may be located in both local and remote memory storage devices.

### INDUSTRIAL APPLICABILITY

In general, embodiments of the present disclosure relate to providing security to an electronic device. Such security may be used to automatically lock, disable, or otherwise secure the electronic device based on the position of the electronic device relative to a separate, additional component which is referred to herein as a security device. Stated simply, some embodiments contemplate allowing the electronic device to operate when it is within a particular range of the security device. If, however, the electronic device is too far away from the security device, and therefore out of the particular range, the electronic device may lock itself. If a user has a particular code, PIN, password, or the like, the user may be able to override the lock, and potentially disable the security-related application. Thus, if a user forgets the security device, he or she may still be able to use the device. A security application may therefore selectively secure the electronic device.

At least some embodiments contemplate making use of a security device that can be integrated in a keychain or other device that can be carried by a user. Typically, the user may carry the security device when using the electronic device. If the user misplaces or loses the security device, software, firmware or other programming executed by the electronic device may lock or disable the electronic device. In some cases, a user may still have access to the electronic device even if the security device is not nearby, by overriding the security controls (e.g., by entering login, override, or other credentials). Further, if the user finds the security device and returns and gets within range of the electronic device, the electronic device may automatically be re-enabled. If the user were to misplace or lose the electronic device—such as where the electronic device is portable—a person finding the electronic device may have difficulty using the device as the device may be locked against some or all use.

The particular range that must be maintained between the electronic device and the security device can be varied. In some embodiments, the range can be set by selecting the protocol used for communication, by the power available to corresponding network interface components, or based on other factors. For instance, in an example embodiment, an electronic device may include a Bluetooth enabled network interface for communicating with a Bluetooth enabled security device. The power available to such interfaces may generally provide a communication range between about fifteen and about fifty feet. In some embodiments, the range is between about twenty and about thirty-five feet. If the electronic device (e.g., smartphone, tablet, e-reader, etc.) were to be moved more than the maximum distance from the security device (or vice versa), the devices may be unable to pair-up, and security features can activate to disable all or a portion of the electronic device. Thus, if a user left a restaurant, car, office, etc. and left a smartphone with security features enabled, the smartphone may disable or lock itself when the user exceeds a maximum communication range of the smartphone and the security device. If the user was to return, the smartphone could continue to check for a connection and automatically re-enable itself, although in some embodiments once locked the user may be required to manually or otherwise unlock the device.

Although the foregoing description contains many specifics, these should not be construed as limiting the scope of the disclosure or of any of the appended claims, but merely as providing information pertinent to some specific embodiments that may fall within the scopes of the disclosure and the appended claims. Various embodiments are described, some of which incorporate differing features. The features illustrated or described relative to one embodiment are interchangeable and/or may be employed in combination with features of any other embodiment herein. In addition, other embodiments of the disclosure may also be devised which lie within the scopes of the disclosure and the appended claims. The scope of the present application is, therefore, indicated and limited only by the appended claims and their legal equivalents. All additions, deletions and modifications to the invention, as disclosed herein, that fall within the meaning and scopes of the claims are to be embraced by the claims.

What is claimed is:

1. A method, comprising:
at an electronic device, identifying a security device;
attempting to communicate with the security device using a wireless communication protocol; and
when communication fails, automatically disabling access to one or more components of the electronic device.

2. The method recited in claim 1, wherein the security device is a dedicated security device.

3. The method recited in claim 1, wherein the security device is a multi-use security device.

4. The method recited in claim 1, wherein identifying the security device and attempting to communicate with the security device include using a low power, short range wireless communication protocol.

5. The method recited in claim 1, wherein the wireless communication protocol includes Bluetooth.

6. The method recited in claim 1, wherein the security device includes a keychain.

7. The method recited in claim 1, wherein attempting to communicate with the security device is performed repeatedly, the method further comprising:
when communication succeeds, abstaining from disabling access to the one or more components of the electronic device.

8. The method recited in claim 1, further comprising:
after automatically disabling access to the one or more components of the electronic device, determining that communication with the security device is again available; and
in response, automatically unlocking the electronic device.

9. The method recited in claim 1, wherein automatically disabling access to one or more components of the electronic device includes locking a user from initiating substantially all uses of the electronic device.

10. The method recited in claim 1, further comprising:
receiving an override input from a user of the electronic device; and
overriding disabled access in response to receipt of the override input.

11. The method recited in claim 1, wherein the security device lacks significant processing and display capabilities.

12. Computer-readable media, comprising:
at least one computer storage medium storing computer-executable instructions that, when executed by one or more processors of an electronic device cause the electronic device to:
identify a security device;
using a wireless communication interface, determine whether the electronic device is currently able to communicate with, or find, the security device; and
base user access to one or more components of the electronic device on the determination of whether the electronic device is able to communicate with, or find, the security device, wherein a lower degree of user access is provided for when the electronic device is not currently able to communicate with, or find, the security device.

13. The computer-readable media recited in claim 12, wherein the wireless communication interface includes a Bluetooth component.

14. The computer-readable media of claim 12, wherein identifying the security device includes identifying a dedicated security-related device.

15. The computer-readable media of claim 14, wherein the dedicated security-related device includes one or more of:
a keychain;
a wristband; or
a pen.

16. The computer-readable media of claim 14, wherein the dedicated security-related device lacks processing capabilities beyond that for communicating with the wireless communication interface of the electronic device.

17. The computer-readable media of claim 12, wherein identifying the security device includes identifying a multi-use security device.

18. The computer-readable media of claim 12, wherein identifying the security device includes obtaining a MAC address of the security device.

19. The computer-readable media of claim 12, wherein determining whether the electronic device is currently able to communicate with, or find, the security device is performed at least at as often as set by a user-configurable delay setting.

20. A method for limiting access to a portable electronic device in the event the portable electronic device is lost, stolen, or accessed without authorization, comprising:
associating at least one security device with a security application on the portable electronic device;
using a short-range wireless radio component of the portable electronic device, connecting to the at least one security device;
repeatedly monitoring a status of a connection between the at least one security device and the portable electronic device;
detecting the connection between the at least one security device and the portable electronic device is lost;
after detecting a lost connection between the at least one security device and the portable electronic device, placing a lock on substantially all access to the portable electronic device; and
triggering display of an override interface requesting input to override the lock on substantially all access to the portable electronic device, the override interface being native to the portable electronic device.
